(19) United States
(12) Patent Application Publication
(10) Pub. No.: US 2006/0105274 A1
(43) Pub. Date: May 18, 2006

(54) Method for forming a lithography mask

(76) Inventors: Karl Kragler, Erlangen (DE); Waltraud Herbst, Uttenreuth (DE); Michael Sebald, Weisendorf (DE); Christoph Hohle, Bubenreuth (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/260,004

(22) Filed: Oct. 27, 2005

(30) Foreign Application Priority Data
Oct. 27, 2004 (DE) 10 2004 052 267.7

(51) Int. Cl. G03C 5/00

(52) U.S. Cl. 430/313; 430/396

(57) ABSTRACT

A method for forming a lithography mask on a surface region of a wafer is presented. In one embodiment of the method according to the invention time periods from the end of an exposure operation until the beginning of a thermal aftertreatment for the sections of the semiconductor material region are to be identical or approximately identical.

### CROSS-REFERENCE TO RELATED APPLICATIONS

This Utility Patent Application claims priority to German Patent Application No. DE 10 2004 052 267.7, filed on Oct. 27, 2004, which is incorporated herein by reference.

### BACKGROUND

One embodiment of the present invention relates to a method for forming a lithography mask, and in particular a method for forming a lithography mask on a semiconductor material region. In one case, the present invention relates to a method for improving the uniformity of sub-50-nanometer structures through thermal aftertreatment of a chemically amplified resist with the aid of a thermal stepper.

The processing of semiconductor structures in many cases involves lithography processes and in particular photolithography processes which are based on the application and formation of so-called photolithography masks that serve as patterning mask for a semiconductor material region lying below the photolithography mask. In order to form such photolithography masks on semiconductor material regions, firstly a material that forms the basis of the photolithography mask to be formed is applied on the surface region of the semiconductor material region, exposed in accordance with structure data present and subsequently developed. After the exposure operation, by means of which the spatial-geometrical structure data are transferred into the material region for the photolithography mask, in many cases a thermal aftertreatment step also takes place, by means of which the structure information transferred by radiation is correspondingly converted into chemical information.

In this case, it is essential to comply with specific temporal relations between the irradiation operation and the thermal aftertreatment step. In known production methods for photolithography masks on surfaces of semiconductor material regions, it is not possible to ensure an identical temporal sequence between irradiation operation and thermal aftertreatment operation for different regions on a semiconductor material region, which is also referred to as a wafer.

### SUMMARY

One embodiment of the invention is a method for producing a photolithography mask in which it is possible to ensure the temporal coordination of the individual process steps for all of the regions of the processed semiconductor material region.

A method according to one embodiment of the invention for forming a photolithography mask on a semiconductor material region including (a) providing a semiconductor material region having a surface region, (b) forming a resist material region having a surface region on the surface region of the semiconductor material region or on a processing partial region thereof, (c) controlling irradiation of the resist material region and thereby formation of a patterned irradiated resist material region at least on or in the processing partial region, (d) thermally aftertreating of the patterned irradiated resist material region at least on or in the processing partial region, and (e) developing of the thermally aftertreated resist material region at least on or in the processing partial region and thereby formation of a patterned resist material region as mask structure on the surface region of the semiconductor material region or on or in a processing partial region thereof.

In one embodiment step (c) is carried out, with regard to the semiconductor material region formed with the resist material region, spatially section-by-section, to be precise with first spatial sections of the semiconductor material region. Step (d) is carried out, with regard to the semiconductor material region formed with the exposed resist material region, likewise spatially section-by-section, to be precise with second spatial sections of the semiconductor material region, the first spatial sections of the material region formed with the exposed resist material region thereby also being correspondingly thermally aftertreated. According to one embodiment of the invention, the respective time period from the end of the exposure of the respective first spatial section of the semiconductor material region until the beginning of the thermal aftertreatment of the respective first section of the semiconductor material region is chosen to be identical or approximately identical for each of the first spatial sections. What is thereby achieved is that all of the first sections of the semiconductor material region and, consequently, the processing partial region of the semiconductor material region are subjected to identical temporal conditions with regard to the resist material, in contrast to the prior art, in which, on account of the so-called first-last die delays, there are time period differences between the exposure and the thermal aftertreatment, which may then also become apparent in material differences or differences in the properties of the differently treated first spatial sections.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIGS. 1A, 1B are schematic plan views illustrating intermediate states of one embodiment of the production method according to the invention.

FIG. 2 is a plan view of a further intermediate state of one embodiment of the method according to the invention.

FIGS. 3A-3H are schematic and sectional side views illustrating intermediate states attained in one embodiment of the production method according to the invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Structurally and/or functionally similar or equivalent structures or method steps are designated by the same reference symbols below. A detailed description of the structural elements or method steps is not repeated on every occasion when they occur.

One embodiment of the present invention forms temporal intervals between the end of the exposure operation and the beginning of the thermal aftertreatment operation to be approximately identical for all of the first spatial sections of the semiconductor material region and thus for all of the sections of the treatment partial region, in order to be able to make the processing results for all of the sections comparable or identical.

One embodiment of the invention proposes a method for forming a lithography mask on a semiconductor material region, having the following steps:
(a) provision of a semiconductor material region having a surface region;
(b) formation of a resist material region having a surface region on the surface region of the semiconductor material region or on a processing partial region thereof;
(c) controlled irradiation of the resist material region and thereby formation of a patterned irradiated resist material region at least on the processing partial region;
(d) thermal aftertreatment of the patterned irradiated resist material region at least in the processing partial region and thereby formation of a thermally aftertreated resist material region; and
(e) development of the thermally aftertreated resist material region at least in the processing partial region and thereby formation of a patterned resist material region as mask structure on the surface region of the semiconductor material region or on a processing partial region thereof;
wherein step (c) is carried out, with regard to the semiconductor material region formed with the resist material region, spatially section by section with first spatial sections of the semiconductor material region;
wherein step (d) is carried out, with regard to the semiconductor material region formed with the patterned exposed resist material region, spatially section by section with second spatial sections of the semiconductor material region, and the first sections of the semiconductor material region formed with the patterned exposed resist material region thereby being thermally aftertreated; and
wherein the respective time period in each case begins with the end of the exposure of the respective first section of the semiconductor material region and in each case ends with the beginning of the thermal aftertreatment of the respective first section of the semiconductor material region being identical or approximately identical or being chosen to be identical or approximately identical for each of the first sections in such a way that the first sections of the semiconductor material region are processed with the same processing quality at least in steps (c) and (d).

In one embodiment of the method according to the invention, it is provided that the first sections of the semiconductor material region and/or the second sections of the semiconductor material region are chosen such that they cover the processing partial region of the semiconductor material region.

As an alternative or in addition, it is conceivable for the first sections of the semiconductor material region and/or the second sections of the semiconductor material region to be chosen such that a first section of the semiconductor material region corresponds to precisely one second section of the semiconductor material region, in one case it is essentially identical thereto.

Furthermore, as an alternative or in addition, it is conceivable for each first section of the semiconductor material region and/or each second section of the semiconductor material region to correspond to a die.

In one case, each first section of the semiconductor material region and/or each second section of the semiconductor material region correspond(s) to an, in one case contiguous, group of dies.

In accordance with one embodiment of the method according to the invention, it is provided that in steps (c) and (d), the first sections of the semiconductor material region are processed individually and/or in groups of first sections of the semiconductor material region in a temporal sequence that is fixed for both steps (c) and (d).

In this case, it may be provided that in step (e), the first sections of the semiconductor material region are processed individually and/or in groups of first sections of the semiconductor material region in the temporal sequence that is fixed for steps (c) and (d).

It is also conceivable that, as an alternative or in addition, in step (c), processing parameters or the totality of all processing parameters for the first sections of the semiconductor material region are identical or approximately identical or are chosen to be identical or approximately identical, in one case with regard to a type of radiation, radiation intensity, radiation energy, radiation power, wavelengths or wavelength ranges, frequencies or frequency ranges, radiation duration, radiation profile, instant for the beginning of the irradiation and/or instant for the end of the irradiation.

It is furthermore possible that, as an alternative or in addition thereto, in step (d), processing parameters or the totality of all processing parameters for the first sections of the semiconductor material region are identical or approximately identical or are chosen to be identical or approximately identical, in one case with regard to the type or the devices, intensity, energy, power, with regard to wavelengths or wavelength ranges, frequencies, or frequency ranges, duration, profile, instant for the beginning of the thermal treatment and/or instant for the end of the thermal treatment.

In step (d), a radiation may be used for heating.

In step (d), an infrared radiation may be used for heating.

In this case, it is possible that in step (d), an arrangement with or comprising infrared diodes is used as heat source, in one case for the local or section-by-section thermal treatment of the first sections of the semiconductor material region or of groups of first sections of the semiconductor material region by irradiation.

Furthermore, as an alternative or in addition, it may be provided that a first or irradiation device is used in step (c), that a second or thermal treatment device is used in step (d), and that the first device and the second device (W1, W2) are coupled to one another—in one case fixedly—geometrically and/or temporally.

In this case, scanning devices, scan devices or stepper devices may be used as first device and/or as second device.

In one case, the first device and the second device are provided in a common treatment unit.

In one embodiment of the method, in step (b), resist material region (31) is formed with or from a chemically amplified resist material or CAR material.

One embodiment of the invention relates to methods for improving the uniformity of sub-50 nm structures through thermal aftertreatment of a chemically amplified resist with the aid of a thermal stepper.

The production of microchips is based on the microlithographic process of structure transfer. This step defines the minimum structure dimensions of the individual circuit elements, the packing density and thus the space requirement of the chips. It is an aim of all chip manufacturers' endeavors to be able to realize ever smaller structures, that is, circuits, on the chip. The smallest structures that are customary at the present time in DRAM memory fabrication lie in the feature size range of 90 to 110 nm.

In photolithography, the so-called chemically amplified resists (chemical amplification resists, CAR) are used to a greater extent for various optical lithography technologies (248 nm, 193 nm, 157 nm and 13 nm). See Solid State Technology, Vol. 39, No. 7, pp. 164-173, (1996). In this case, the resists may work according to the principle of acid-catalyzed cleavage. By way of example, in the case of positively working resists, a polar carboxylic acid group is formed here from a nonpolar chemical group, for example a tert-butyl carboxylate group, in the presence of a photolytically produced acid (photo acid). In a subsequent development step, the exposed resist film is treated with aqueous alkaline developer solutions, the carboxylic acid-rich, polar regions being removed by development and the unexposed resist regions remaining. Corresponding acid-catalyzed crosslinking reactions are effected in the case of negative systems.

These acid-catalyzed cleavage processes or crosslinking processes generally take place at temperatures in the range of 80 to 160° C. This means that in the lithography process heating steps are necessary, the so-called PEB or post exposure bake, that is to say a heating step effected after the exposure.

For this post exposure bake, use is made of so-called hotplates, in principle simple electrical precision heating plates which, however, guarantee a very exact temperature adjustment and distribution over the heating area (typical tolerance fluctuations over the heating area <1° C.). The substrates to be processed (silicon wafer or else a mask blank) are placed onto the heating area of the hotplates by means of an automated mechanism and are thus heated by direct mechanical contact. It is likewise possible for the substrates to be heated contactlessly by way of a very thin air cushion (<1 mm) between hotplate and substrate in the case of so-called proximity hotplates. This method using hotplates is used globally on an industrial scale as the only method for processing both the chemically amplified resists and the non-amplified resists.

As a result of the increasing reduction of the feature sizes, in particular with dimensions ranging below 50 nm, an effect becomes apparent here which may be referred to as first/last die effect or first/last die delay. In modern exposure devices, the entire Si wafer is no longer exposed, but rather only individual fields comprising one or more chips, the so-called die. As a result of the successive exposure of the individual fields—in one case in a stepper or scanner—a time difference now arises between the first and last exposure fields on the wafer. Thus, for example, in the case of a 256 Mbit chip on a 300 mm wafer there are approximately 250 exposure fields, that is to say that with a cycle of for example, 500 ms the delay between first and last dies adds up to a good two minutes. In the case of high-resolution patterning (for example, in 157 nm lithography), this time difference may become apparent adversely in the structure dimension obtained, since it is not taken into account during the PEB on a hotplate by means of the heat treatment of the entire wafer all at once. While in the exposed regions a high acid diffusibility influences the desirable protective group cleavage, a time-dependent lateral diffusion (typical average diffusion lengths lie in the range of 10 nm-30 nm) into the nominally unexposed regions is undesirable, because this ultimately leads, depending on the time period between exposure and PEB (the so-called post exposure delay), to the alteration of the feature sizes on the wafer. (See W. Hinsberg et al., “Extendibility of Chemically Amplified Resists: Another Brick Wall?”, Pro. SPIE Vol. 5039 (2003), page 1.) The result is an inadequate uniformity—from a production engineering standpoint—of the structures over the entire wafer.

The neutralization of acid by aminic contaminants from the air, which are only able to be monitored in a complicated manner, likewise plays a part in the first/last die effect. The resulting effects are likewise time-dependent.

One embodiment of the present invention is intended to present a method by means of which the first/last die delay can be avoided. This is done by virtue of the fact that the PEB is no longer effected by means of a conventional hotplate, but rather by means of a thermal stepper subsequent to the exposure.

One embodiment of the invention solves the problem by virtue of the fact that the individual dies are in each case thermally treated (subjected to heat treatment) at an identical temporal interval relative to their preceding exposure. This is achieved by virtue of the fact that the exposed wafer is no longer subjected to heat treatment as an entire wafer, but rather with the aid of a stepper-like device which can selectively subject an exposure field to heat treatment by means of thermal radiation. This thermal stepper is adapted to the die-to-die exposure cycle of the exposure device.

In one embodiment of the invention, the first/last die delay is completely avoided as a result of the selective heat treatment and the adapted cycle with respect to the exposure device. The temporal interval between exposure and PEB is identical for each exposed field.

In one embodiment of the invention, such a thermal stepper can be linked directly to an exposure device, or be integrated in a clustered track, analogously to the tracks used hitherto. Through the use of a plurality of stations, the total throughput of an exposure device is not affected.

In one embodiment of the invention, by virtue of the heat treatment by means of thermal radiation, it is no longer necessary to heat the entire wafer. Only the actually required region of the wafer (namely the exposed photoresist) is subjected to heat treatment. By way of the associated lower overall heat capacity and more effective heating of the resist, this discloses the possibility of possibly shortening PEB times (times of approximately 60-90 seconds have typically been used hitherto).

In one embodiment of the invention, the use of thermal radiation affords the possibility of carrying out the PEB in vacuo. In this case, with lithography techniques such as for example, E-beam or EUV (extreme UV), both of which take place in vacuo, the PEB could likewise be carried out in vacuo as it were in situ after the exposure. In this case, the exposed resist no longer comes into contact with air and thus with amines prior to the PEB.

In one embodiment of the invention the wafer is no longer subjected to heat treatment as a whole, rather each individual exposure field is subjected to heat treatment selectively and in a manner adapted to the exposure cycle of these fields. As a result, the time period between exposure and PEB is identical for each field and CD (critical dimension) fluctuations from field to field are completely avoided as a result. The uniformity over the entire wafer is thereby considerably improved.

### EXAMPLE 1

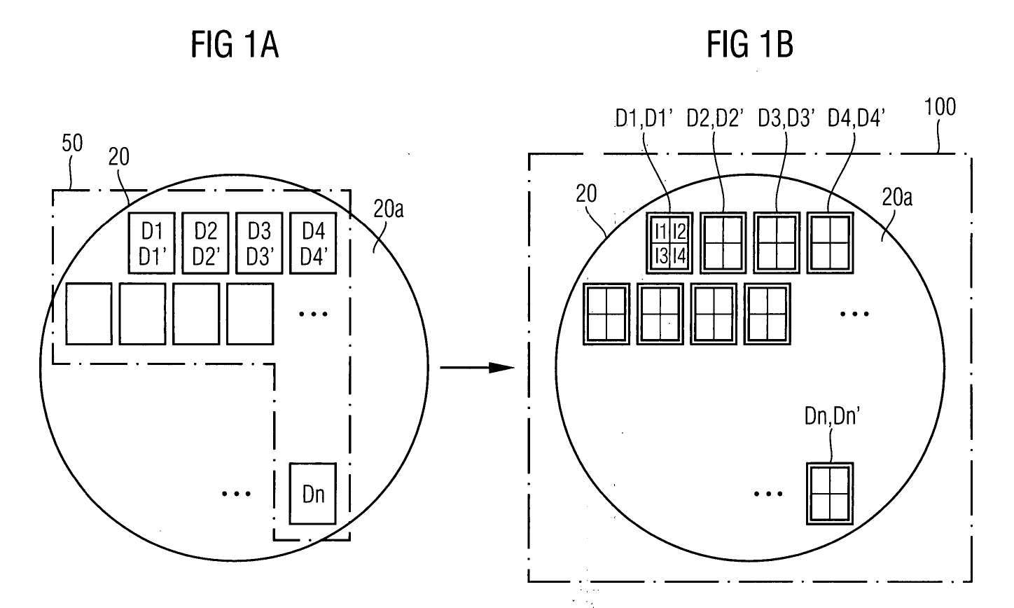

The thermal stepper is realized with the aid of a clocked IR diode array. FIGS. 1A and 1B are intended to illustrate this principle of an IR diode array stepper:

FIG. 1A illustrates a plan view of a wafer with some exposure fields, which are also called dies. For simplification, the dies are not depicted true to scale and are not depicted completely. FIG. 1B illustrates a schematic diagram of a thermal stepper having an IR diode array in a transparent view from above. Beneath the array, the exposed wafer is moved into the thermal stepper by means of a suitable handler and aligned. The array is arranged such that after loading the dies are situated precisely beneath the diodes and a diode array is situated opposite each die.

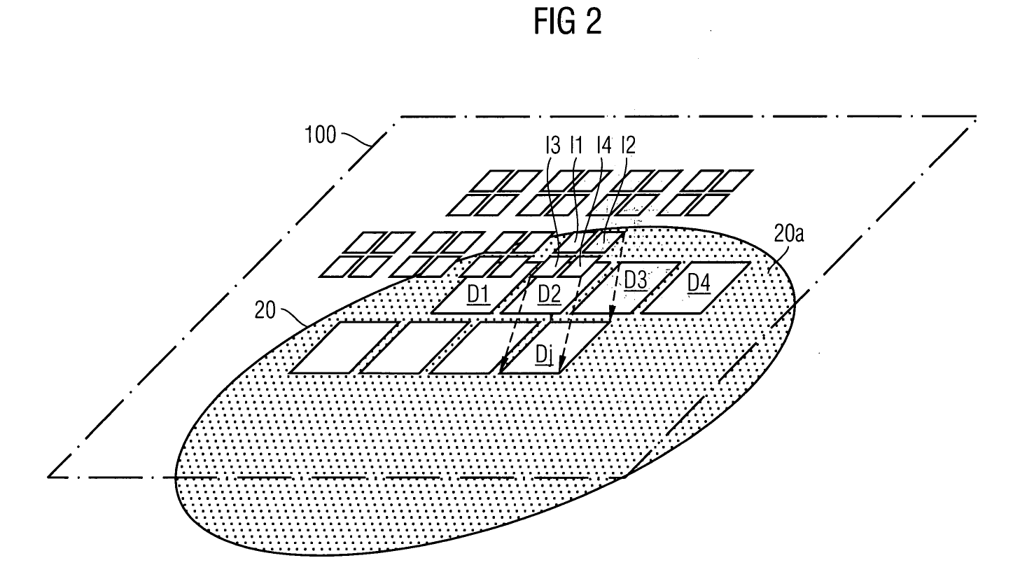

FIG. 2 schematically illustrates the operation of the thermal stepper. The radiation characteristic of the array is designed such that precisely one die is heated. This may be effected by means of suitable heat shields made, that is, of steel. By virtue of the arrays being switched on and switched off in a clocked manner synchronously with the exposure device, the temporal interval between exposure and PEB can be kept identical for all of the fields. In parallel with this, the wafer is held at a defined temperature from the underside in order to enable the heated resist to be cooled after the array has been switched off. Afterward, the wafer is moved out of the stepper for further processing.

### EXAMPLE 2

In this variant, the clocked IR diode array used in example 1 is replaced by radiant heating with a variable diaphragm. The radiant heating consists for example, of electrical heating elements. A quartz radiator—in one case without a UV component—may also be used. The diaphragm system is realized in such a way that a cooled individual diaphragm is arranged above each die, said individual diaphragm being folded upward, by way of example. These diaphragms are opened and closed again in accordance with the exposure cycle. In principle, each die is then heated analogously to FIG. 2 in example 1.

FIGS. 1A, 1B and 2 illustrate, in the form of schematic plan views, intermediate states attained in one embodiment of the method according to the invention for forming a lithography mask 40 on a semiconductor material region 20.

FIG. 1A illustrates a semiconductor material region 20 having a surface region 20a. The semiconductor material region 20 may also be referred to as a wafer. Specific first sections D1 to Dn are illustrated on the wafer, the totality of which sections form the so-called processing partial region 50 on the wafer 20. The first sections D1 to Dn are also referred to as exposure fields, processing fields or as so-called dies. These dies D1 to Dn practically form those regions of the entire semiconductor material region 20 which, after the entire production operation has proceeded, are then detached and singulated from the wafer 20 in order then to form in each case by themselves corresponding semiconductor circuit modules or chips. The sections D1 to Dn or dies D1 to Dn practically also define those regions in the entire semiconductor material region 20 in which the exposure operation (c) according to one embodiment of the invention for the patterning of the resist material region 31 in each case takes place, the latter being formed on the surface region 20a of the semiconductor material region 20 but not being explicitly illustrated here in FIG. 1A. In the assembly of the semiconductor material region 20, the first sections D1, . . . , Dn which here correspond to the second sections D1′, . . . , Dn′ form the processing partial region 50 of the semiconductor material region 20.

FIG. 1B illustrates a processing device 100 in the form of a so-called thermal stepper 100, which is arranged over the wafer 20 with the exposed resist material region 32 on the surface 20a thereof. Infrared diodes 11 to 14 are indicated schematically in each of the sections, exposure fields or dies D1, . . . , Dn, which diodes in each case lie above the section D1, . . . , Dn to be processed and are exposed to thermal radiation during a corresponding thermal treatment (d).

FIG. 2 illustrates, in a schematic and perspective view, the process (d) of exposing one of the sections Dj to infrared radiation by means of the infrared diodes I1 to 14 of the processing device 100, that is to say of the thermal stepper, it becoming clear that the infrared diodes I1 to I4 actually irradiate the respective geometrically assigned exposure field Dj, that is to say the corresponding die Dj, with infrared radiation.

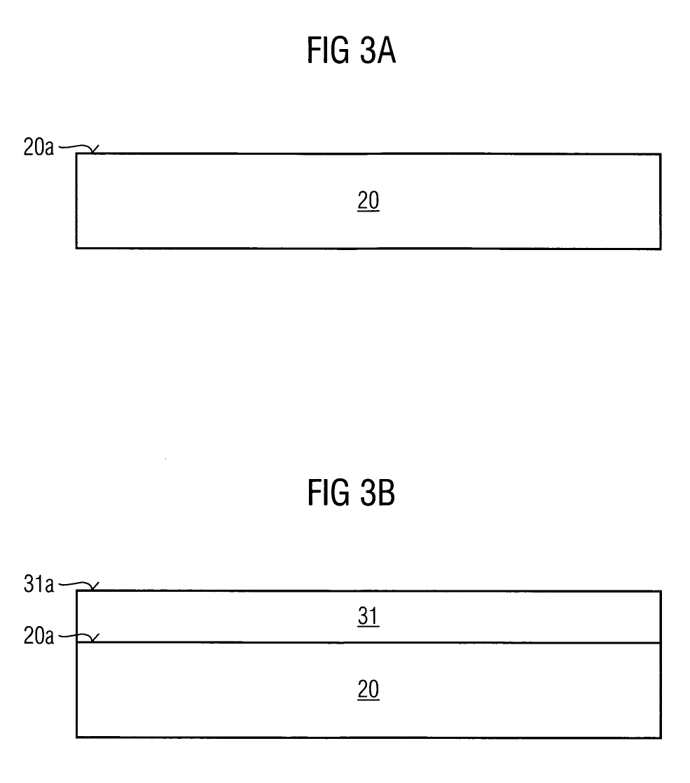

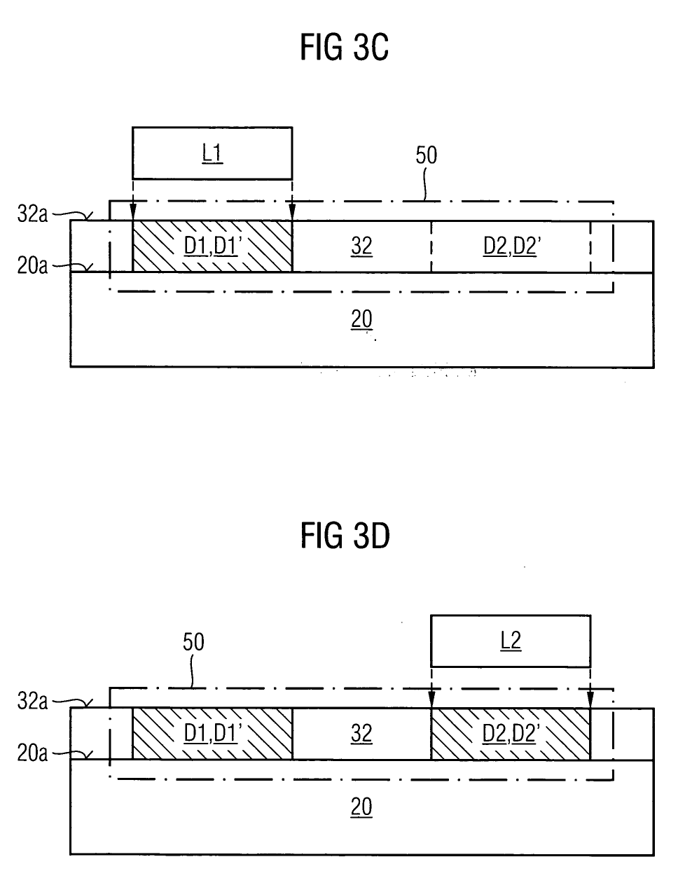

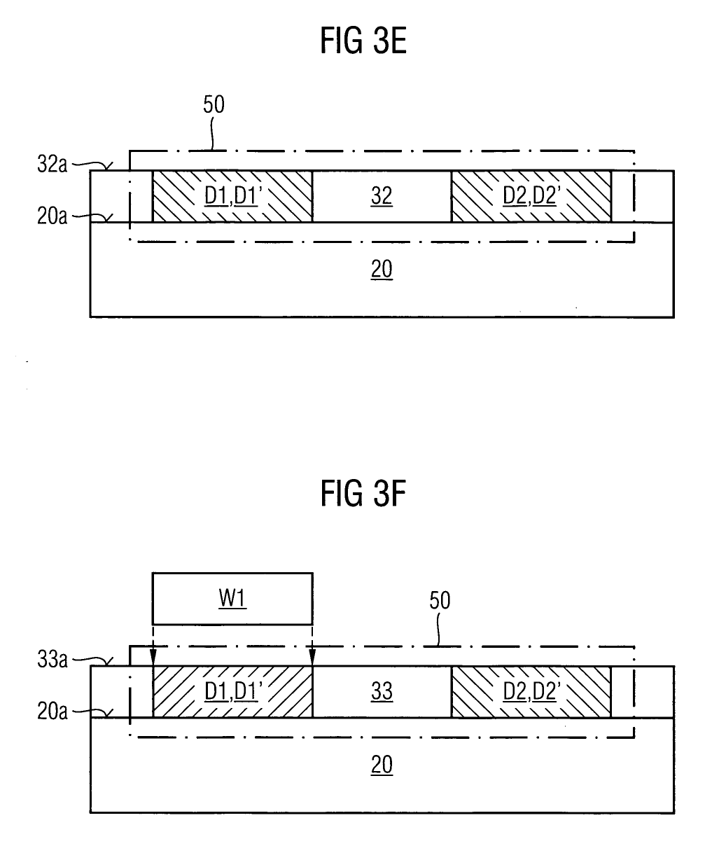

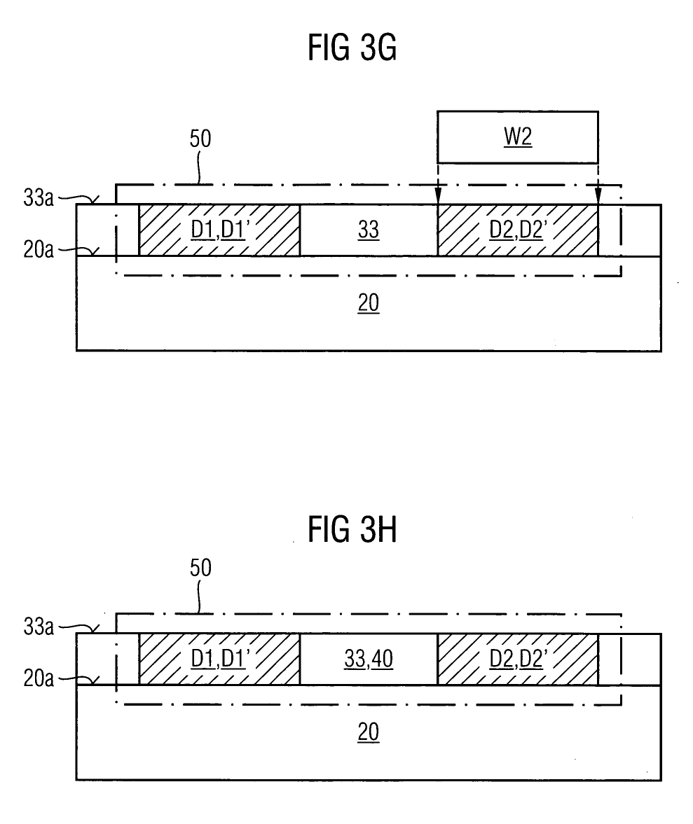

The sequence of FIGS. 3A to 3H schematically illustrates, in sectional side view, intermediate states attained in another embodiment of the production method according to the invention.

In the intermediate state of FIG. 3A, firstly a semiconductor material region 20 or wafer 20 having a surface region 20a is provided.

In the transition to the intermediate state illustrated in FIG. 3B, a resist material region 31 having a surface region 31a is then formed on the surface region 20a of the wafer 20.

In the transition to the intermediate state illustrated in FIG. 3C, firstly a first section D1 of the semiconductor material region 20 with the resist material region 31 provided thereabove is irradiated by an irradiation device L, so that, at the location of this first section D1 of the semiconductor material region 20, the resist material region 31 present there is patterned by means of exposure to radiation.

In the transition to the situation illustrated in FIG. 3D, the irradiation device L is then positioned at the position of a second section D2 of the semiconductor material region 20 with the resist material region 31 provided thereabove, where it performs a corresponding irradiation, whereby the resist material region 31 is in turn patterned there by means of light.

FIG. 3E illustrates the semiconductor material region 20 after the conclusion of the irradiation operation (c), the patterned irradiated resist material region 32 now being present on the surface region 20a of the semiconductor material region 20.

In the transition to the intermediate state of FIG. 3F, the thermal treatment device W is then positioned in the region of the first section D1 of the semiconductor material region 20 with the patterned irradiated resist material region 32, and a corresponding thermal aftertreatment (d) is carried out locally for the first section D1.

In the transition to the intermediate state of FIG. 3G, the thermal treatment device W is then brought to the position of another first section D2, the thermal aftertreatment step (d) then being carried out there locally for this further first section D2.

FIG. 3H then illustrates the patterned thermally aftertreated wafer 20 with the corresponding first sections D1 and D2 of the semiconductor material region 20 with the patterned thermally aftertreated resist material region 33 provided thereabove, the development operation (e), which is not illustrated any further here, then subsequently having to be carried out on the structure thus obtained.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method for forming a lithography mask on a semiconductor material region, comprising:
providing a semiconductor material region having a surface region;
forming a resist material region having a surface region on the surface region of the semiconductor material region or on a processing partial region thereof;
controlling irradiation of the resist material region and thereby forming a patterned irradiated resist material region at least on the processing partial region;
thermally aftertreating the patterned irradiated resist material region at least in the processing partial region and thereby forming a thermally aftertreated resist material region; and
developing the thermally aftertreated resist material region at least in the processing partial region and thereby forming a patterned resist material region as mask structure on the surface region of the semiconductor material region or on a processing partial region thereof;
wherein controlling irradiation is carried out, with regard to the semiconductor material region formed with the resist material region, spatially section by section with first spatial sections of the semiconductor material region;
wherein thermally aftertreating is carried out, with regard to the semiconductor material region formed with the patterned exposed resist material region, spatially section by section with second spatial sections of the semiconductor material region, and the first sections of the semiconductor material region formed with the patterned exposed resist material region thereby being thermally aftertreated;
wherein the respective time period begins with the end of the exposure of the respective first section of the semiconductor material region and ends with the beginning of the thermal aftertreatment of the respective first section of the semiconductor material region and is identical for each of the first section; and
wherein the first sections of the semiconductor material region are processed with the same processing quality at least in controlling irradiation and thermally aftertreating.

2. The method of claim 1 further comprising choosing the first sections of the semiconductor material region and/or the second sections of the semiconductor material region such that they cover the processing partial region of the semiconductor material region.

3. The method of claim 1 further comprising choosing the first sections of the semiconductor material region and/or the second sections of the semiconductor material region such that a first section of the semiconductor material region corresponds to precisely one second section of the semiconductor material region.

4. The method of claim 1, wherein the first section of the semiconductor material region is essentially identical to one second section of the semiconductor material region.

5. The method of claim 1, wherein each first section of the semiconductor material region and/or each second section of the semiconductor material region correspond(s) to a die.

6. The method of claim 1, wherein each first section of the semiconductor material region and/or each second section of the semiconductor material region correspond(s) to a group of dies.

7. The method of claim 1, wherein the group of dies are contiguous.

8. The method of claim 1, wherein in controlling irradiation and thermally aftertreating the first sections of the semiconductor material region are processed individually and/or in groups of first sections of the semiconductor material region in a temporal sequence that is fixed.

9. The method of claim 6, wherein in developing the thermally aftertreated resist, the first sections of the semiconductor material region are processed individually and/or in groups of first sections of the semiconductor material region in the temporal sequence that is fixed for controlling irradiation and thermally aftertreating.

10. The method of claim 1, wherein in controlling irradiation, one or more of a group of processing parameters comprsing a type of radiation, radiation intensity, radiation energy, radiation power, wavelengths or wavelength ranges, frequencies, frequency ranges, radiation duration, radiation profile, instant for the beginning of the irradiation and instant for, the end of the irradiation for the first sections of the semiconductor material region are chosen to be identical.

11. The method of claim 1, wherein in thermally aftertreating, one or more of a group of processing parameters comprising type of the devices, intensity, energy, power, with regard to wavelengths, wavelength ranges, frequencies, frequency ranges, duration, profile, instant for the beginning of the thermal treatment and instant for the end of the thermal treatment for, the first sections of the semiconductor material region are chosen to be identical.

12. The method of claim 1 further comprising using a radiation for heating in the thermal aftertreatment.

13. The method of claim 1 further comprising using infrared radiation for heating in the thermal aftertreatment.

14. The method of claim 13, wherein in thermally aftertreating an arrangement with infrared diodes is used as heat source.

15. The method of claim 14 further including a section-by-section thermal treatment of the first sections of the semiconductor material region or of groups of first sections of the semiconductor material region by irradiation.

16. The method of claim 1, wherein an irradiation device is used in controlling irradiation wherein a thermal treatment device is used thermally aftertreating, and wherein the irradiation device and the thermal treatment device are coupled to one another.

17. The method of claim 16, wherein one of the group comprising scanning devices, scan devices and stepper devices are used as first device and/or as second device.

18. The method of claim 16, wherein the first device and the second device are provided in a common treatment unit.

19. The method of claim 1 wherein in forming the resist material region the resist material region is formed with or from a chemically amplified resist material or CAR material.

20. A semiconductor material region with a lithography mask, comprising:
means for providing a semiconductor material region having a surface region;
means for forming a resist material region having a surface region on the surface region of the semiconductor material region;
means for controlling irradiation of the resist material region and thereby forming a patterned irradiated resist material region on the surface region of the semiconductor material region;
means for thermally after treating the patterned irradiated resist material region and thereby forming a thermally aftertreated resist material region; and
means for developing the thermally aftertreated resist material region and thereby forming a patterned resist material region as mask structure on the surface region of the semiconductor material region;
wherein controlling irradiation is carried out, with regard to the semiconductor material region formed with the resist material region, spatially section-by-section with first spatial sections of the semiconductor material region;
wherein thermally aftertreating is carried out, with regard to the semiconductor material region formed with the patterned exposed resist material region, spatially section-by-section with second spatial sections of the semiconductor material region; and the first sections of the semiconductor material region formed with the patterned exposed resist material region thereby being thermally aftertreated;
wherein the respective time period begins with the end of the exposure of the respective first section of the semiconductor material region and ends with the beginning of the thermal aftertreatment of the respective first section of the semiconductor material region and is identical for each of the first section; and
wherein the first sections of the semiconductor material region are processed with the same processing quality at least in controlling irradiation and thermally aftertreating.
